(19) United States
(12) Patent Application Publication
(10) Pub. No.: US 2026/0120515 A1
(43) Pub. Date: Apr. 30, 2026

(54) SYSTEMS AND METHODS FOR DETECTING PRESENTATION ATTACKS IN CONTACTLESS FINGERPRINT AND FACIAL RECOGNITION AND FOR ENHANCING FINGERPRINT AND FACIAL VIDEO RECOGNITION-BASED IDENTITY VERIFICATION

(71) Applicant: George Mason University, Fairfax, VA (US)

(72) Inventors: Emanuela MARASCO, Alexandria, VA (US); Raghavendra RAMACHANDRA, Hunndalen (NO)

(21) Appl. No.: 19/368,114

(22) Filed: Oct. 24, 2025

Related U.S. Application Data
(60) Provisional application No. 63/712,244, filed on Oct. 25, 2024.
(60) Provisional application No. 63/724,696, filed on Nov. 25, 2024.

(51) Int. Cl. G06V 40/40; G06T 7/149; G06V 10/80

(52) U.S. Cl. CPC G06V 40/40; G06T 7/149; G06V 10/80; G06T 2207/20084

(57) ABSTRACT

A method of detecting presentation attacks based on a finger or face image in a first color space captured by an image capture device. The method includes receiving a first color space image in the first color space, converting the first color space image into a number of additional color space images, wherein each additional color space image is in a color space other than the first color space, and providing the first color space image and the number of additional color space images to a trained attention-leveraged data fusion-based classification system that is configured to determine whether the original image is live or a spoof. Also, a facial or finger video-based biometric authentication system and method employed combined losses during training to train a backbone network for performing vide-based identity verification.

### CROSS REFERENCE TO RELATED APPLICATIONS

This application claims priority to U.S. Provisional Patent Application Ser. No. 63/712,244, filed on Oct. 25, 2024, and titled “Late Deep Fusion to Enhance Finger Photo Presentation Attack Detection,” and U.S. Provisional Patent Application Ser. No. 63/724,696, filed on Nov. 25, 2024, and titled “Finger-Video Comparison for Contactless Identity Verification,” the disclosures of which is incorporated herein by reference in its entirety.

### STATEMENT OF GOVERNMENT INTEREST

This invention was made with government support under grant number CNS-1822094 awarded by the National Science Foundation. The government has certain rights in the invention.

### FIELD OF THE INVENTION

The disclosed concept relates generally to biometric authentication systems, and, in particular, to systems and methods for detecting presentation attacks in contactless fingerprint and facial recognition systems and for providing fingerprint and facial video-based identity verification.

### BACKGROUND OF THE INVENTION

As the use of mobile devices, such as smartphones and tablets, has proliferated, the management and transmission of personal data, such as, without limitation, financial data or health records, using such devices has increased. In order to attempt to secure those transactions, mobile devices are increasingly using biometric authentication techniques (e.g., contactless fingerprint and/or facial recognition). In fact, biometric identity verification has become a cornerstone of mobile security, enabling identity verification through face and fingerprint recognition.

Moreover, the demand for robust security and seamless user identity verification is allowing growth in mobile biometric adoption. For example, smartphone cameras enable contactless biometric fingerprint capture for reliable identity verification in various practical applications, including mobile voting, BFSI (Banking, Financial Services, and Insurance), and healthcare sectors. Government initiatives promote the integration of these technologies into public services and enterprises. For instance, through the Mobile Biometric Application (MBA) program, FBI agents and federal task force officers (TFOs) use mobile devices (e.g., cell phones and tablets) to confirm an individual's identity in situations and locations where mobile biometric identification is necessary, such as mass arrests and natural disasters. Unfortunately, this growth has also increased the motivation for malicious individuals to launch presentation attacks (PAs) using various presentation attack instruments (PAIs), such as photographs, masks, fake silicone fingerprints, and video replays.

In addition, although contactless fingerprint and facial recognition can effectively secure these devices, the technology is weakened by various factors, including changes in the specifics of a smartphone or tablet, background and illumination variations, and exposure to presentation attacks as noted above. Although presentation attack detection (PAD) algorithms can fortify the system against these threats, current algorithms are not designed to handle the fast innovation and continuous evolution of devices.

Modern smartphones have changed the photography function significantly, with upgraded cameras featuring high definition, night mode, and anti-shake characteristics. These changes contribute to PAD performance degradation. In critical applications impacting human beings, creating trustworthy decision-making systems is essential. Capture bias is related to how the images are acquired, both in terms of the device used and of the collector preferences for point of view, lighting conditions, etc. If not addressed, these concerns can increase mistrust of fingerprint or facial recognition technology for biometric authentication.

Furthermore, technological discrimination can occur when embedded optical sensors inadequately capture the features of individuals from marginalized groups. The way in which these systems handle different skin tones can mitigate ethical and security concerns. This, however, has been understudied. A key challenge is the current limitation of optical sensor technology, which often struggles to accurately identify individuals with highly pigmented skin. This issue is particularly pronounced with RGB imaging technology and deep learning models for processing fingerprint images, which, as noted above, are becoming alternatives to traditional contact-based scanners. The inadequacies in these technologies can result in lower accuracy and reliability for users with darker skin tones.

PAD is a vital component of mobile biometric authentication. Effective PAD technologies must be robust against various spoofing techniques, ensuring that only genuine fingerprints are accepted. However, biases in existing AI models can lead to higher false rejection rates for individuals with darker skin tones or those whose features do not align well with the training data used to develop these models. This bias not only compromises security, but also exposes marginalized groups to more significant risks of being unfairly denied access or misidentified.

In addition, finger and facial videos can be obtained using commodity smartphone cameras without requiring a dedicated sensor, such as a fingerprint sensor, or any physical contact. Furthermore, verification using a video may be more robust since static data, whether of faces or fingerprints, is more susceptible to presentation attacks like spoofing techniques that utilize printed images or images displayed on screens, master prints, and/or dictionary attacks. Finger and facial videos add a dynamic component by including finger or facial movement in the biometric verification process. This dynamic aspect makes it significantly more difficult for an attacker to create a convincing spoof, as they would need to precisely mimic the intricate and natural movement of the finger or face. Despite the advantages of video-based biometric verification, applications and analyses of techniques that utilize this input modality have been extremely limited.

### SUMMARY OF THE INVENTION

In one embodiment, a method detecting a presentation attack in a computing device based on a finger or face image in a first color space captured by an image capture device of the computing device is provided. The method includes receiving a first color space image in the first color space, wherein the first color space image either is or is based on the finger or face image, converting the first color space image into a number of additional color space images, wherein each additional color space image is in a color space other than the first color space, and providing the first color space image and the number of additional color space images to a trained attention-leveraged data fusion-based classification system. The trained attention-leveraged data fusion-based classification system includes a plurality of deep neural networks and a plurality of channel attention blocks, wherein each deep neural network is coupled to a respective one of the channel attention blocks, wherein each of the first color space image and the number of additional color space images is provided to a respective one of the deep neural networks, wherein for each deep neural network data based on first output features from the deep neural network is provided to the channel attention block of the deep neural network, wherein each attention block produces second output features, and wherein the trained attention-leveraged data fusion-based classification system classifies the finger or face image as a live image or a spoof based on the second output features from each of the channel attention blocks.

In another embodiment, a computing device configured for detecting presentation attacks is provided. The computing device includes an image capture device and a processing apparatus implementing a trained attention-leveraged data fusion-based classification system and being structured and configured for receiving a first color space image in a first color space, wherein the first color space image either is or is based on a finger or face image captured by the image capture device, wherein the finger or face image is in the first color space, converting the first color space image into a number of additional color space images, wherein each additional color space image is in a color space other than the first color space, and providing the first color space image and the number of additional color space images to the trained attention-leveraged data fusion-based classification system. The trained attention-leveraged data fusion-based classification system includes a plurality of deep neural networks and a plurality of channel attention blocks, wherein each deep neural network is coupled to a respective one of the channel attention blocks, wherein each of the first color space image and the number of additional color space images is provided to a respective one of the deep neural networks, wherein for each deep neural network data based on first output features from the deep neural network is provided to the channel attention block of the deep neural network, wherein each attention block produces second output features, and wherein the trained attention-leveraged data fusion-based classification system is structured and configured to classify the finger or face image as a live image or a spoof based on the second output features from each of the channel attention blocks.

In other embodiments, a novel biometric authentication system and method is provided that utilizes finger or facial videos for biometric identity verification. The biometric authentication system and method are based on a Siamese architecture-based approach as both the gallery and the probe data are processed by the same model. In addition, biometric authentication system and method use a combination of a plurality of different losses during training to train a backbone neural network that is to perform the finger or face video-based authentication.

### BRIEF DESCRIPTION OF THE DRAWINGS

A full understanding of the invention can be gained from the following description of the preferred embodiments when read in conjunction with the accompanying drawings in which:

FIG. 1 is a block diagram of a PAD architecture according to a non-limiting exemplary embodiment of the disclosed concept;

FIG. 2 is a flowchart showing a method of detecting whether an RGB facial or fingerprint image is bona fide or a spoof using the exemplary PAD architecture of FIG. 1;

FIG. 3 is a schematic diagram of a PAD architecture according to one particular exemplary embodiment of the disclosed concept;

FIG. 4 is a schematic diagram of a PAD architecture according to another particular exemplary embodiment of the disclosed concept;

FIG. 5 is a block diagram of a computing device according to an exemplary embodiment of the disclosed concept that implements a local PAD system for facilitating biometric authentication;

FIG. 6 is a biometric authentication system according to an alternative exemplary embodiment of the disclosed concept;

FIG. 7 is a block diagram of a biometric identity verification architecture for detecting whether a facial or finger video is verified according to a non-limiting exemplary embodiment of the disclosed concept;

FIG. 8 is a flowchart showing a video-based biometric identity verification method according to an exemplary embodiment of the disclosed concept;

FIG. 9 is a schematic diagram illustrating a method of training a facial or finger video-based biometric identity verification architecture according to a non-limiting exemplary embodiment of the disclosed concept;

FIG. 10 is a block diagram of a computing device according to an exemplary embodiment of the disclosed concept that implements a local facial or finger video-based biometric identity verification architecture; and

FIG. 11 is a facial or finger video-based biometric identity verification system according to another alternative exemplary embodiment of the disclosed concept.

### DETAILED DESCRIPTION OF THE INVENTION

As used herein, the singular form of “a”, “an”, and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs.

As used herein, the term “number” shall mean one or an integer greater than one (i.e., a plurality).

As used herein, the terms “component” and “system” are intended to refer to a computer related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers. While certain ways of displaying information to users are shown and described with respect to certain figures or graphs as screenshots, those skilled in the relevant art will recognize that various other alternatives can be employed.

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

As noted in W. James, The Principles of Psychology, volume 1, Cosimo, Inc., 2007, attention “implies withdrawal from some things to deal effectively with others,” and makes humans perceive, comprehend, and distinguish more effectively. Thus, according to one aspect, as described in detail herein, the disclosed concept provides a novel hybrid PAD architecture that combines various color spaces and multiple trained deep neural networks (e.g., multiple convolutional neural networks (CNNs)), each leveraging attention to a different color space. The corresponding embeddings created by each deep neural network are then integrated via feature-level fusion to arrive at a determination of whether an image that is presented is bona fide (i.e., a live image) or a spoof (i.e., PA).

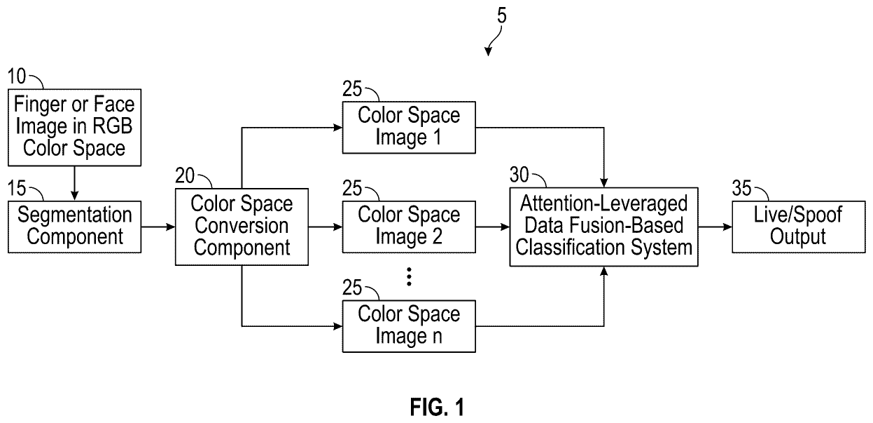

FIG. 1 is a block diagram of a trained PAD architecture 5 for detecting whether an RGB facial or fingerprint image 10 is bona fide or a spoof according to a non-limiting exemplary embodiment of the disclosed concept. PAD architecture 5 includes a segmentation component 15 that is structured and configured to isolate a region of interest (ROI) in RGB facial or fingerprint image 10, for example using a trained segmentation model such as, without limitation, Faster R-CNN or a U-Net segmentation network. PAD architecture 5 further includes a color space conversion component 20 that is coupled to segmentation component 15 for receiving the segmented RGB image data generated by segmentation component 15. Color space conversion component 20 is structured and configured to convert the segmented RGB image data into a number of different color spaces. This, as seen in FIG. 1, color space conversion component 20 outputs a plurality of color space images 25, one of which is the original segmented RGB image. For example, in the non-liming exemplary embodiment, color space conversion component 20 is structured and configured to convert the segmented RGB image data into data in the HSV and YCbCr color spaces. More specifically, in this non-limiting exemplary embodiment, the RGB pixel values at coordinates (x, y) are transformed into two additional color spaces, HSV[H(x,y), S(x,y) and V(x,y)] and YCbCr[Y(x,y),Cb(x,y), Cr(x,y)] to create a unified representation. This results in a nine-channel vector for each pixel:

$$C ( x , y ) = [ R ( x , y ) , G ( x , y ) , B ( x , y ) ,$$

$$H ( x , y ) , S ( x , y ) , V ( x , y ) ,$$

$$Y ( x , y ) , Cb ( x , y ) , Cr ( x , y ) ]$$

This unified representation combines the strengths of all three color spaces (RGB, HSV, and YCbCr), enabling a richer representation of color variations across different skin tones. The final representation is normalized and converted into a tensor suitable for neural network input.

In one particular exemplary embodiment, the color space derivation may be performed as follows:

$$V ( x , y ) = max ( R ( x , y ) , G ( x , y ) , B ( x , y ) )$$

$$S ( x , y ) = \{ \begin{matrix}0 & if V ( x , y ) = 0 \\ \frac{Δ ( x , y )}{V ( x , y )} & otherwise\end{matrix}$$

$$H ( x , y ) = \{ \begin{matrix}0 & if S ( x , y ) = 0 \\ \frac{Angle ( R , G , B )}{Δ ( x , y )} & otherwise\end{matrix}$$

$$where Δ ( x , y ) = V ( x , y ) - min ( R ( x , y ) , G ( x , y ) , B ( x , y ) )$$

For YCbCr conversion, the image's RGB components are transformed into the Y (luminance), Cb (blue-difference chrominance), and Cr (red-difference chrominance) channels as follows:

$$Y ( x , y ) = 0.299 R ( x , y ) + 0.587 G ( x , y ) + 0.114 B ( x , y )$$

$${C}_{b} ( x , y ) = \frac{B ( x , y ) - Y ( x , y )}{2} + 0.5$$

$${C}_{r} ( x , y ) = \frac{R ( x , y ) - Y ( x , y )}{2} + 0.5$$

These RGB, HSV, and YCbCr components are concatenated to form a 9-dimensional vector C(x, y), normalized as:

$${C}_{norm} ( x , y ) = \frac{1}{255} \times [ R ( x , y ) , G ( x , y ) , B ( x , y ) , \text{} H ( x , y ) , S ( x , y ) , V ( x , y ) , Y ( x , y ) , {C}_{b} ( x , y ) , {C}_{r} ( x , y ) ]$$

This normalized representation is then transformed into a tensor suitable for neural network input as follows:

$${C}_{tensor} ( x , y ) = permute ( {C}_{norm} ( x , y ) , order = [ 2 , 0 , 1 ] )$$

While the exemplary embodiment described above Includes transformation of RGB image data into HSV and YCbCr color spaces, it will be understood that other color spaces may also be employed in addition to or instead of HSV and YCbCr color spaces, such as, without limitation, XYZ and LAB color spaces.

Referring again to FIG. 1, PAD architecture 5 includes an attention-leveraged data fusion-based classification system 30 that is structured and configured to receive the data for each of the color space images 25 and to determine whether RGB facial or fingerprint image 10 is bona fide or a spoof. Attention-leveraged data fusion-based classification system 30 includes a plurality of trained deep neural networks, wherein each deep neural network corresponds to and receive data for a different color space. In addition, attention-leveraged data fusion-based classification system 30 employs channel attention wherein the features (e.g., embeddings) output by each deep neural network are provided to an associated channel attention mechanism (e.g., an SENet (Squeeze-and-Excitation Network)) which computes and applies channel-specific weights. As a result, each deep neural network leverages attention to a different color space. Thus, by employing channel attention, attention-leveraged data fusion-based classification system 30 focuses on which channels are more informative for the task and learns to weight them (during both training and inference) accordingly. The corresponding embeddings created by each deep neural network and associated channel attention mechanism are then integrated via feature-level fusion to arrive at a determination 35 of whether an image that is presented is bona fide (i.e., a live image) or a spoof (i.e., PA).

As noted above, before implementation as PAD system, attention-leveraged data fusion-based classification system 30 is trained and tested using labelled facial or fingerprint RGB image data (truth data). More specifically, each deep neural network and associated channel attention mechanism are trained and tested with such truth data so that the channel weights can be determined.

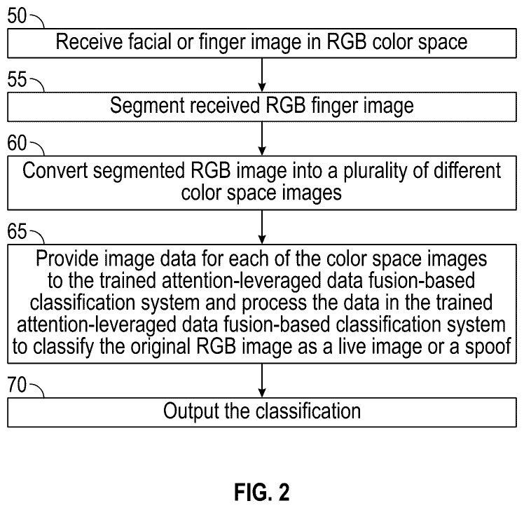

FIG. 2 is a flowchart showing a method of detecting whether an RGB facial or fingerprint image 10 is bona fide or a spoof using the exemplary PAD architecture 5. It would be appreciated, however, that this is meant to be exemplary only, and that the method may also be employed in connection with alternative PAD architectures. The method begins at step 50, wherein a digital RGB finger or face image 10 is received in PAD architecture 5. Next, at step 55, the received RGB finger or face image 10 is segmented using segmentation component 15. Then, at step 60, the segmented RGB image is converted into a plurality of different color space images. As noted above, in the exemplary embodiment, the other color spaces that are employed are HSV and YCbCr. At step 65, the data for each of the color space images is provided to the trained attention-leveraged data fusion-based classification system 30, where such data is processed to classify the original RGB image as a live image or a spoof. The output of the classification is then provided at step 70. As will be appreciated, the output provided at step 70 may be used by a pad system to determine whether or not to authenticate a user of a device based on the received RGB finger or face image 10. PAD architecture 5 emptying attention-leveraged data fusion-based classification system 30 thus provides an advantageous improvement to biometric authentication systems that may be employed in devices such as mobile devices, including smartphones and tablets.

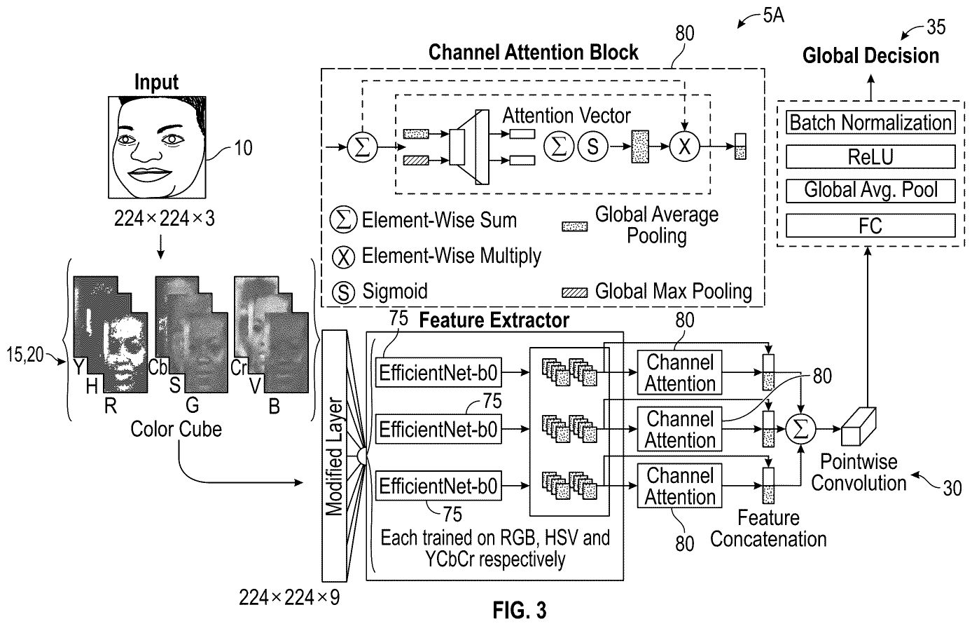

As noted elsewhere herein, conventional PAD approaches frequently fail to capture the subtle chromatic variations in skin pigmentation across different skin types, leading to potential biases and inaccuracies. FIG. 3 is a schematic diagram of a PAD architecture 5 (labelled 5A) according to one particular exemplary embodiment that addresses this weakness and provides improved PAD functionality by leveraging data from multiple color spaces, including RGB, HSV, and YCbCr, to model a n-channel image. This representation integrates a richer set of features that capture the variations of different skin tones. As seen in FIG. 3, PAD architecture 5A inputs a face or finger photo RGB image 10 as described herein (size 224×224×3 in the illustrated exemplary embodiment). This image is converted into a unified nine-channel representation (size 224×224×9) as described herein in the RGB, HSV, and YCbCr color spaces by segmentation component 15 and color space conversion component 20. As seen in FIG. 3 and as described in more detail herein, the attention-leveraged data fusion-based classification system 30 of this particular exemplary embodiment uses three parallel trained EfficientNet-B0 convolutional neural networks (CNNs) 75, each with an associated channel attention block 80. The channel attention mechanism extracts relevant channel-wise features that capture subtle differences in skin tone. The outputs from the individual channel-attention blocks 80 are concatenated to obtain the features that are then processed through the final layers of attention-leveraged data fusion-based classification system 30 as described herein to make predictions (Live or Spoof) about the input face or finger photo RGB image 10.

More specifically, in attention-leveraged data fusion-based classification system 30 of PAD architecture 5A, the first layer is modified to accommodate the input dimension of the unified nine-channel representation (RGB, HSV, and YCbCr) of the input face or finger photo RGB image 10. The three EfficientNet B0 CNNs/models 75 are used as the backbone for feature extraction. Each EfficientNet-B0 CNN 75 is trained from scratch on an image data set, such as the ImageNet Dataset described in Jia Deng, Wei Dong, Richard Socher, Li-Jia Li, Kai Li, and Li Fei-Fei. Imagenet: A large-scale hierarchical image database, 2009 IEEE Conference on Computer Vision and Pattern Recognition, pp. 248-255, 2009, using RGB, HSV, and YCbCr color spaces. For each EfficientNet-B0 CNN/model 75, also identified as Φi, the feature map Φi(Ctensor(x, y)) is computed as follows:

$${Φ}_{i} ( {C}_{tensor} ( x , y ) ) = EfficientNet - B {0}_{i} ( {C}_{tensor} ( x , y ) ) , i ∈ \{ RGB , HSV , YCbCr \}$$

Feature maps Φᵢ(Ctensor(x, y)) extracted from each of the EfficientNet-B0 CNNS/models 75 are individually processed through a single associated channel-attention block 80 (also labeled A herein) to emphasize the most relevant features separately across different RGB, HSV, and YCbCr color space models as follows:

$$\begin{matrix}A ( {Φ}_{i} ( {C}_{tensor} ( x , y ) ) ) = σ ( ( GlobalAvgPool ( {Φ}_{i} ( {C}_{tensor} ( x , y ) ) ) \\ + GlobalMaxPool ( {Φ}_{i} ( {C}_{tensor} ( x , y ) ) ) ) \cdot W + b ) \\ ⊙ {Φ}_{i} ( {C}_{tensor} ( x , y ) )\end{matrix}$$

Here, σ is the sigmoid function, scaling values between 0 and 1. Learnable parameters W and b adjust during training, while element-wise multiplication ⊙ applies the attention weights to the feature map Φᵢ(Ctensor(x, y)), prioritizing critical features across RGB, HSV, and YCbCr.

In addition, as shown in FIG. 3, the output feature maps from each attention block 80 are concatenated into a single combined feature map Fconcat. Specifically, the outputs from each channel attention block 80 are processed individually and then combined using element-wise summation as shown below:

$${F}_{concat} = A ( Φ ( {C}_{tensor} ( x , y ) ) )$$

Subsequently, the refined features are passed through a series of operations, including batch normalization, ReLU activation, and global average pooling. Finally, a fully connected layer makes the final decision on whether the input face or finger photo RGB image 10 is live or a spoof.

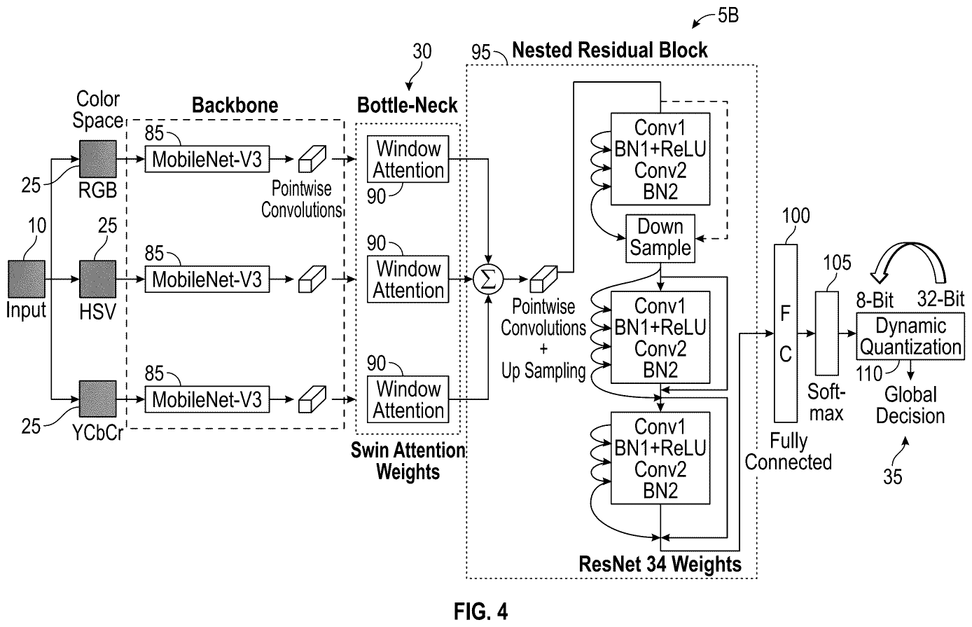

FIG. 4 is a schematic diagram of a PAD architecture 5 (labelled 5B) according to another, alternative particular exemplary embodiment that addresses that provides improved PAD functionality by leveraging data from multiple color spaces, including RGB, HSV, and YCbCr, to model an n-channel image. As seen in FIG. 4, PAD architecture 5B inputs a face or finger photo RGB image 10 as described herein that is converted into a unified nine-channel representation as described herein in the RGB, HSV, and YCbCr color spaces by segmentation component 15 (using Faster R-CNN in this embodiment) and color space conversion component 20 (FIG. 1). Thus, like PAD architecture 5A shown in FIG. 3, PAD architecture 5B leverages different color models which possess complementary information to improve PAD performance. In addition, as seen in FIG. 4 and as described in more detail herein, the attention-leveraged data fusion-based classification system 30 of this particular exemplary embodiment uses three parallel trained MobileNet V3 Large convolutional neural networks (CNNs) 85 in the backbone, each with an associated window channel attention block 90. The MobileNet V3 CNNs 85 process each color space separately. These models have a lightweight architecture, and are thus advantageous for mobile applications with limited computational resources. They efficiently extract features from every color space without subjecting them to heavy computation as would be expected with more complex models. PAD architecture 5B is initialized using pre-trained weights from models previously trained on a suitable database, such as ImageNet database described herein. The outputs from the individual window channel-attention blocks 90 are concatenated to obtain the features that are then processed through the final layers of attention-leveraged data fusion-based classification system 30 as described herein to make predictions (Live or Spoof) about the input face or finger photo RGB image 10.

More specifically, as seen in FIG. 4, in attention-leveraged data fusion-based classification system 30 of PAD architecture 5B, features extracted by the individual MobileNet V3 CNNs 85 are subjected to pointwise convolution followed by a bottleneck framework where each individual network incorporates a window attention mechanism 90. The weights of the attention layer are initialized with predefined weights of the Swin transformer finetuned on finger or facial photos, as appropriate. In addition, as seen in FIG. 4, the features from the three attention layers, representing various color spaces, are combined via element-wise addition, mixing channels through pointwise convolution. The output is fed into a nested residual block 95. Nested residual block 95 includes multiple convolutional layers with skip connections. In the exemplary implementation, the blocks are initially set up with weights from a previously trained ResNet-34 model. Finally, a fully connected layer 100 with a SoftMax layer 105 leads to the global decision. Dynamic quantization 110 is applied to compact the model's size and enhance its deployment efficiency on various mobile platforms.

Window attention is a variant of the attention mechanism that considers local regions (windows) in the input feature map. In PAD architecture 5B, the input color feature map provided by each individual MobileNet V3 CNNs 85 is partitioned into non-overlapping tiles, each being a X×X sub-region (7×7 in the non-limiting exemplary implementation). Within each of these tiles, self-attention is computed independently, enabling the model to capture relationships and dependencies within localized regions of the input feature map. In the non-limiting exemplary implementation, window attention mechanism 90 takes as input feature maps represented in d=768 dimensions. This mechanism partitions inputs non-overlapping windows where each window has height Wh=Ww=7, width denoted by Ww and height denoted by Wh, respectively in the non-limiting exemplary implementation. Consequently, in the non-limiting exemplary implementation, a single window comprises N=Wh×Ww=49 tokens. To manage the high-dimensional input efficiently within these localized regions, the mechanism employs h=24 attention heads, with each head operating on a reduced dimension of dh=d/h=32 in the non-limiting exemplary implementation. This setup facilitates parallel processing across multiple aspects of the input within each window, enhancing the model's capability to distill pertinent features from localized segments of the feature map. The Q, K, V indicate the query, key, value matrices within each window and per head, and they are generated by applying a linear layer on X∈RN×dh, the feature map of each window, respectively, as shown below:

$$Q , K , V = Linear ( X ) ∈ {ℝ}^{N \times {d}_{h}}$$

The window attention in each head can be written as below:

$$Attention ( Q , K , V ) = Soft Max ( \frac{{QK}^{T}}{\sqrt{{d}_{h}}} + B ) V$$

where B∈RN×N is a relative position bias per head. Output features from the attention operation between Q,K, V, and for multiple heads are mixed through a linear layer.

Nested residual block 95 is a composite structure that enhances input features X using convolutional layers, normalization techniques and nonlinear activations integrated into a residual learning framework. Nested residual block 95 performs an initial transformation through a convolutional layer Conv1 followed by batch normalization BN1 and ReLU activation.

$${X}_{1} = ReLu ( {BN}_{1} ( Con {υ}_{1} ( X ) ) )$$

It then applies down-sampling X_{down} to extract higher level features and further processes these features. Subsequently, it up-samples them back to their dimensions Xᵤₚ. Nested residual block 95 culminates by merging the Xᵤₚ features with the initial transformation via a residual connection Xres and produces the final output Y through another convolution Conv2 and batch normalization BN2 as shown below:

$$Y = {BN}_{2} ( Con {υ}_{2} ( {X}_{res} ) )$$

This design enables the network to capture information in multi-scales effectively while ensuring smooth gradient flow, for training models.

Dynamic quantization mechanism 110 concentrates more on the weights during inference, which helps in efficiently compressing the most memory-consuming sections of the model. This is a dynamic process since it does scale and zero-point calculations at runtime that are adaptive to the actual data distribution; thus, accuracy is maintained regardless of decreased precision. To optimize for model tensor and inference speed, this method maps 8-bit integers in range [−128, 127] by floating point values representation.

Algorithm 1 Dynamic Quantization

| | |
|---|---|
| 1: | Identity Fₘᵢₙ and Fₘₐₓ, the minimum and maximum values |
| | in tensor F from a model. |
| 2: | $Calculate scale S as \frac{{F}_{max} - {F}_{min}}{255} .$ |
| 3: | $C alculate zero point Z as round ( \frac{- {F}_{min}}{S} ) - 128.$ |
| 4: | for each value f in F do |
| 5: | $Quantize f to Q = round ( \frac{f - {F}_{min}}{S} ) - 128.$ |
| 6: | end for |
| 7: | for each value q in Q do |
| 8: | Dequantize q to F′ = (q + 128) × S + Fₘᵢₙ. |
| 9: | end for |
| 10: | return Quantized tensor Q and dequantized tensor F′. = 0 |

Algorithm 1 above provides an overview of how dynamic quantization works. As seen, it converts the floating-point tensor into 8-bit one by scaling them down with respect to their maximum absolute value before rounding off. By quantizing model weights as lower-precision integers, the disclosed concept can decrease both memory usage and computational demands of the model while limiting its parameter size. Such compression methods are very useful in deploying PAD architecture 5B on smartphones or other resource-limited hardware without sacrificing much accuracy.

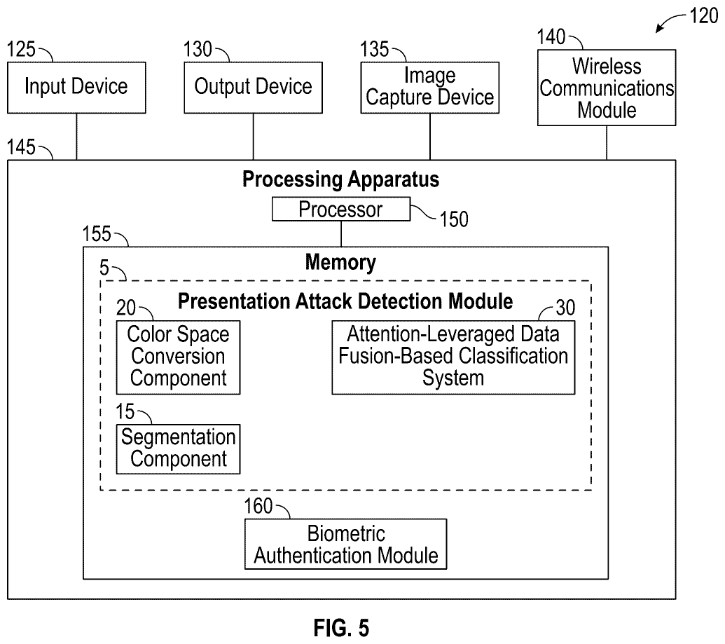

FIG. 5 is a block diagram of computing device 120 according to an exemplary embodiment of the disclosed concept that implements a local PAD system for facilitating biometric authentication of a user of computing device 120. Computing device 120 may be, for example and without limitation, a smartphone, a tablet computer or a PC. To implement the local PAD system, computing device 120 employs PAD architecture 5 (e.g., PAD architecture 5A or 5B) of the disclosed concept.

Referring to FIG. 5, computing device 120 includes an input device 125 (such as a keyboard or touchscreen), an output device 130 (such as an LCD), a digital image capture device 135 (such as a CCD camera), a wireless communications module 140 (such as a Wi-Fi module and/or a broadband (e.g. cellular) wireless communication module) and a processing apparatus 145. A user is able to provide input into processing apparatus 145 using input device 125 and image capture device 135, and processing apparatus 145 provides output signals to output device 130 to enable output device 130 to display information to the user as described herein. Processing apparatus 145 comprises a processor 150 and a memory 155. Processor 150 may be, for example and without limitation, a microprocessor (μP), a microcontroller, or some other suitable processing device, that interfaces with memory 155. Memory 155 can be any one or more of a variety of types of internal and/or external storage media such as, without limitation, RAM, ROM, EPROM(s), EEPROM(s), FLASH, and the like that provide a storage register, i.e., a non-transitory machine readable medium, for data storage such as in the fashion of an internal storage area of a computer, and can be volatile memory or nonvolatile memory. Memory 155 has stored therein a number of routines (comprising computer executable instructions) that are executable by processor 150, including routines for implementing PAD architecture 5 (e.g., PAD architecture 5A or 5B) of the disclosed concept as described herein. In particular, memory 155 includes segmentation component 15, color space conversion component 20, and attention-leveraged data fusion-based classification system 30.

In addition, memory 155 includes a biometric authentication module 160 structured and configured to enable the biometric authentication of a user based on a facial or fingerprint image. More specifically, biometric authentication module stores an a facial or fingerprint image of the user, for example as a digital template, that is captured by image capture device 135 during an enrollment phase. Thereafter, during a verification phase, to authenticate the user the user will compare another facial or fingerprint image captured by image capture device to the skin thicker hair vibrant energy strong image stored during enrollment, typically using a matching algorithm. Farmer if similarity is determined to be above a certain threshold, computing device 120 will authenticate the user, And, for example, grant access to computing device 120 or applications on or accessed through computing device 120. PAD Architecture 5 implemented on computing device 120 operates in conjunction with biometric authentication module to prevent presentation attacks. In particular, PAD architecture 5 will first analyze a facial or finger image presented for authorization purposes to determine whether it is a live image or a spoof (i.e. a PA). The image will only be passed to biometric authentication module 160 for verification if it is determined to be a live image by PAD architecture. PAD architecture 5 thus provides an improvement to computing device 120, and in particular to its biometric authentication technology, by detecting and preventing presentation attacks.

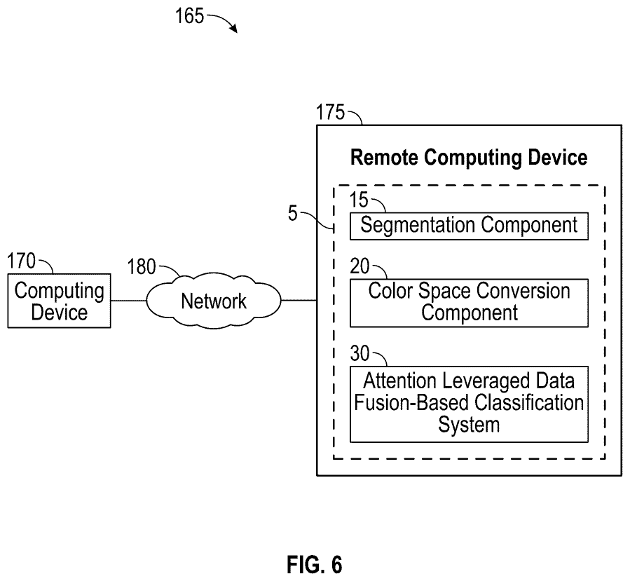

FIG. 6 is a biometric authentication system 165 according to an alternative exemplary embodiment of the disclosed concept. As seen in FIG. 6, biometric authentication system 165 includes a user computing device 170, such as a tablet computer, smartphone or PC, and a remote computing device 175, such as a server computer. User computing device 170 is similar to computing device 120 of FIG. 5, and includes an input device 125, an output device 130, an image capture device 135, a wireless communications module 140, and a processing apparatus 145. User computing device 170 and remote computing device 175 are able to securely communicate with one another via a wired and/or wireless network 180, including, for example, the Internet. In this embodiment, remote computing device 175 implements PAD architecture 5 remotely in order to allow a user of user computing device 170 to be authenticated with the protections of a PAD system. Thus, in operation, facial or finger images captured by computing device 170 may be sent to remote computing device 175 for a determination of live or spoof as described herein. In biometric authentication system 165, the biometric authentication module 160 may be resident on either computing device 170 or remote computing device 175. In either case, biometric authentication module 160 will utilize the output of PAD architecture 5 during the process of authenticating a user based on a facial or finger image that is presented via computing device 170 as described herein. Biometric authentication system 165 thus presents a solution wherein the PAD functionality is implemented in a remote location and is accessed by computing device 170 as needed.

A further aspect of the disclosed concept provides a novel biometric authentication approach that utilizes finger or facial videos with movement in multiple poses for biometric identity verification. As used herein in connection with this aspect of the disclosed concept, the term “gallery” shall mean a reference database of users for which access to a system is allowed (i.e., autotomized users), containing information from a collection of finger and/or face videos from those users to be used for identity verification. As used herein in connection with this aspect of the disclosed concept, the term “probe” refers to new samples being presented for verification and captured during the verification process. As described herein, samples from the probe are compared against the gallery during the verification process. As used herein in connection with this aspect of the disclosed concept, the term “identity” refers to a unique face or finger entity; each finger is considered an identity even when they belong to the same person. As used herein in connection with this aspect of the disclosed concept, the term “verification” is the process in which the system and method of the disclosed concept check a probe against the gallery to determine whether it matches one of the registered identities. The system and method will identify a probe as an imposter if it is not a registered identity. Otherwise, the system and method will recognize a probe as genuine and correctly predict that the identity of the input matches.

As described in detail herein, this aspect of the disclosed concept is based on a Siamese architecture-based approach as both the gallery and the probe data are processed by the same model. In addition, this aspect of the disclosed concept uses a combination of three different losses during training to train a backbone neural network that is to perform the finger or face video-based authentication. More specifically, cosine embedding loss, binary classification loss, and VICReg loss are used for effectively training the backbone neural network on video data. In one particular embodiment, the model uses a binary classification loss function based on self-class balancing focal loss. Moreover, when registering authentic identities from the gallery, the system and method of the disclosed concept extract and store the features (embeddings) of the videos. The probe videos also undergo the same feature extraction process when verifying new identities. For a particular probe identity, the system and method of the disclosed concept then compare it to the identities in the gallery, returning a match score for each one. Also, during training, and as shown and described herein, the system is augmented with an expander and a binary classifier to compute the auxiliary losses. During inference, however, these extra modules are discarded, and only the trained backbone is used, which makes the system more efficient.

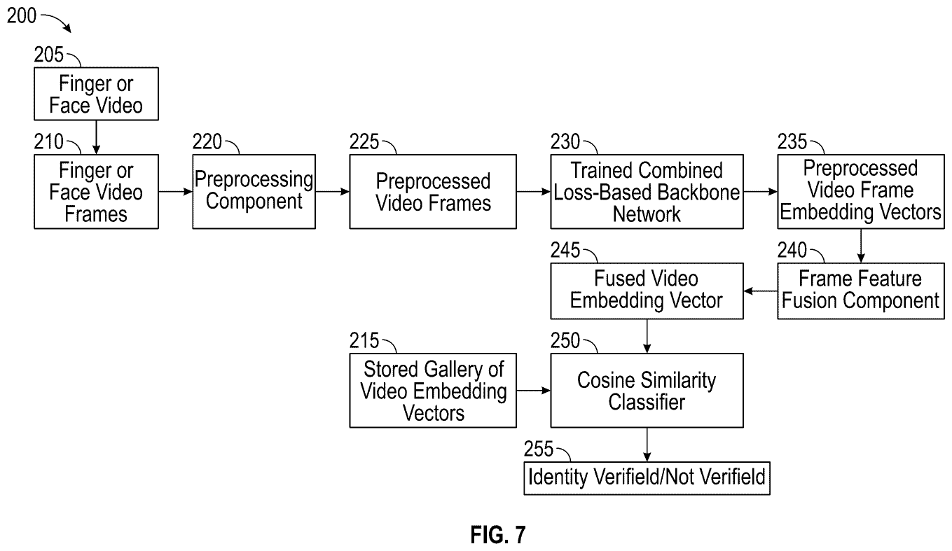

FIG. 7 is a block diagram of a biometric identity verification architecture 200 for detecting whether a face or finger video 205 (with movement in multiple poses) comprising a plurality of finger or face video frames 210 is verified according to a non-limiting exemplary embodiment of the disclosed concept. Biometric identity verification architecture 200 includes a gallery comprising stored gallery video embedding vectors 215 that are created from the videos of the gallery using the same trained model (described herein) that is used to process facial or finger video 205. Facial or finger video 205 is thus a probe presented for verification against the gallery comprising gallery video embedding vectors 215.

The face or finger in face or finger video 205 is dynamic and will move along various axes. Hence, its location and orientation may keep changing across different video frames. It will therefore be advantageous to preprocess the frames to make it easier for the model described herein to make comparisons. Specifically, in the exemplary embodiment, the face or finger in each frame needs to be segmented and aligned along a fixed axis. Biometric identity verification architecture 200 thus further includes a preprocessing component 220 that is structured and configured to process finger or face video frames 210 to segment and align the finger or face presented therein and to produce preprocessed video frames 225. For finger images, the exemplary embodiment utilizes a non-learning-based contour-finding algorithm described in Hanzhuo Tan and Ajay Kumar, Minutiae attention network with reciprocal distance loss for contactless to contact-based fingerprint identification, IEEE Transactions on Information Forensics and Security, 16:3299-3311, 2021, owing to its accuracy and simplicity. It is noted, however, that any suitable finger segmentation algorithm can be used in its stead. The algorithm finds several contours in the image; the largest one is chosen. All pixels outside this contour are set to zero. An elliptical approximation is then performed to find the best ellipse that aligns with the contour. Using the angle of the ellipse, the central axis (and hence the contour) of the finger is aligned parallel to the vertical axis such that the finger points vertically downward. The image is further cropped using the lowest point of the contour as a reference point to get the outermost section of the finger that is furthest away from the hand. To make the ridges in the fingerprint more visible, contrast-limited adaptive histogram equalization (CLAHE) is also performed.

Biometric identity verification architecture 200 also includes a trained combined loss-based backbone network 230. Trained combined loss-based backbone network 230 comprises a trained neural network, such as a trained CNN or a transformer-based backbone Swin transformer. In one particular exemplary implementation, combined loss-based backbone network 230 is a trained MobileNetV3-Large due to its ease of use, efficiency, and applicability in mobile devices As described in more detail herein, trained combined loss-based backbone network 230 is trained using a combination of three types of losses: (i) cosine embedding loss, (ii) binary classification loss, and (iii) VICReg loss. Trained combined loss-based backbone network 230 is structured and configured to produce an embedding vector for each of the preprocessed video frames 225. These embedding vectors are identified with reference numeral 235 in FIG. 7. Biometric identity verification architecture 200 further includes a frame feature fusion component 240 that is structured and configured to receive preprocessed video frame embedding vectors 235 and generate a single fused video embedding vector 245 based thereon. In the exemplary embodiment, single fused video embedding vector 245 is generated by statistically averaging the preprocessed video frame embedding vectors 235.

Biometric identity verification architecture 200 still further includes a cosine identity classifier 250. Cosine identity classifier 250 is structured and configured to receive fused video embedding vector 245 and gallery video embedding vectors 215 and generate a classification output 255 based thereon of (i) either identity verified, or (ii) identity not verified. In particular, cosine identity classifier 250 is structured and configured to receive fused video embedding vector 245 and compare the embeddings therein against gallery video embedding vectors 215. If they have are determined to have a cosine similarity above a designated threshold, the identity is considered a match and thus verified.

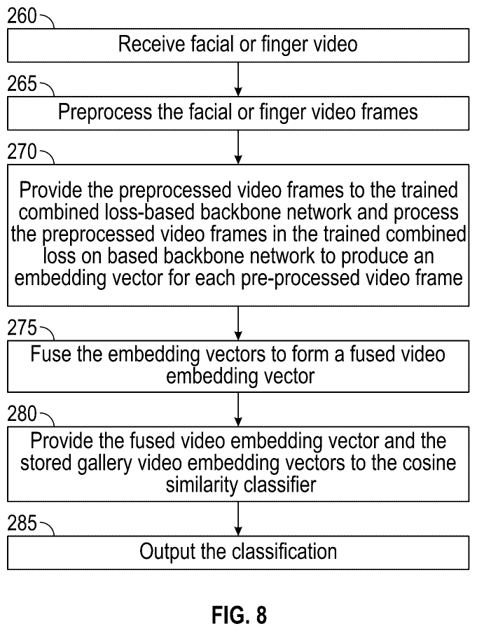

FIG. 8 is a flowchart showing a biometric identity verification method according to an exemplary embodiment using biometric identity verification architecture 200. The method begins at step 260, wherein finger or face video 205 is received. Then, at step 265, the finger or face video frames 210 of finger or face video 205 are preprocessed in preprocessing component 220. The preprocessed video frames 225 are then provided to trained combined loss-based backbone network 230 at step 270. Also in step 270, the preprocessed video frames 225 are processed in trained combined loss-based backbone network 230 to produce preprocessed video frame embedding vectors 235. Then, at step 275, frame feature fusion component 240 fuses the preprocessed video frame embedding vectors 235 to produce fused video embedding vector 245. At step 280, fused video embedding vector 245 and stored gallery video embedding vectors 215 are provided to cosine similarity classifier 250. Cosine similarity classifier 250 will then, at step 285, output a classification in the form of a determination of whether the identity of the individual that provided finger or face video 205 is verified/authenticated.

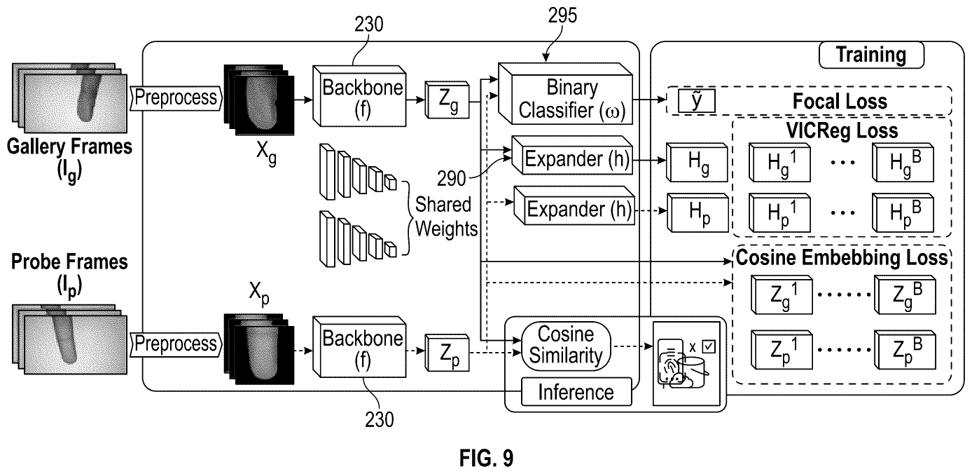

The training process utilized in this aspect of the disclosed concept is illustrated in FIG. 9. As noted elsewhere herein, during training, the system of the disclosed concept uses a combination of the types of losses: (i) cosine embedding loss, (ii) binary classification loss, and (iii) VICReg loss. The main loss is the cosine embedding loss, which does not need any new weights since the embeddings can be directly used to get the loss. However, the binary classification loss and the VICReg loss requires new weights. As seen in FIG. 9, the system of the disclosed concept is augmented during training with an expander 290 and a binary classifier model 295 to compute the VICReg loss and the binary classification loss (self-class balancing focal loss in the exemplary embodiment), respectively.

VICReg loss is based on variance, invariance and covariance minimization. The loss is most effective when the embeddings have a high dimensionality. Expander 290 thus converts the original dimension (d) to (D) where D≥2d. In the exemplary embodiment, expander 290 is a simple two-layer fully connected model. The VICReg loss is given by the following equation:

$$\text{?} ( \text{?} , \text{?} ) = λ s ( \text{?} , \text{?} ) + μ [ \text{?} ( \text{?} ) + υ ( \text{?} ) ] + v [ c ( \text{?} ) + c ( \text{?} ) ]$$

$$\text{?} \text{indicates text missing or illegible when filed}$$

Cosine embedding loss is used in a contrastive manner such that each video from the gallery (Zg) lies close to its counterpart(s) in the probe (Zp) if they belong to the same identity and farther if they belong to different identities as shown in the equation below:

$${ℒ}_{cos} ( {Z}_{g} , {Z}_{p} ) = \{ \begin{matrix}1 - cos ( {Z}_{g} , {Z}_{p} ) & if y = 1 \\ max ( 0 , cos ( {Z}_{g} , {Z}_{p} ) ) & if y = 0\end{matrix}$$

This loss does not require any new weights to be added to the model unlike the other two losses used.

With respect to binary classification loss, to make the prediction, binary classifier model 295 takes as input the concatenated embeddings of the two videos, i.e. [Zg,Zp]. In the exemplary embodiment, binary classifier model 295 is a simple two-layer fully connected network with relu activations between layers which predicts 1 if they belong to the same identity and 0 otherwise. This loss is given by the equation below:

$$\text{?} = c \text{?} s ( {Z}_{g} , {Z}_{p} ) \{ \begin{matrix}log ( \text{?} ) & if y = 1 \\ log ( 1 - \text{?} ) & if y = 0\end{matrix}$$

$$\text{?} \text{indicates text missing or illegible when filed}$$

The total loss, which is used in trained combined loss-based backbone network 20, is the combination of all three losses and is given by the equation below:

$$ℒ = \text{?} + {w}_{cos} {ℒ}_{cos} + \text{?}$$

$$\text{?} \text{indicates text missing or illegible when filed}$$

In one particular implementation, the models are trained using LARS optimizer with a learning rate of 0.2 and a polynomial learning rate scheduler of power 0.9 for 2000 iterations. A weight decay of 1e-4 and a batch size of B=256, i.e., 256 image pairs per batch were used. The expanded embedding dimension is set to fixed size d̅=8192 for VICReg loss calculation. To make the model more robust to size, scale, blur, and lighting variation, random augmentations were used during training: random color-jitter, random rotation, random resized crop, random grayscale, and random Gaussian blur.

In addition, to ensure that all losses contribute equally, the following settings were used in the total loss equation above: wvic=1, wcos=1, and wcls=1. For VICReg loss, the following settings were used: v=0.01 and λ=μ=1.0. For focal loss, the following settings were used: α=0.25 and γ=2. Also, is has been empirically found that the binary classifier scores are less reliable than cosine similarity scores, so they are discarded in the exemplary embodiment. The videos are sampled with a fixed rate set to 1/10 to discard redundant frames with low information. This results in an effective frame rate of 3 fps since the videos are initially 30 fps with N≈200 frames per video. During training, by default, all such N frames are considered as possible data, from which a batch is formed by random uniform sub-sampling. However, n=10 frames randomly sampled from the N possible image frames using uniform sampling are used for better efficiency during inference. Finally, in this exemplary implementation, training is performed using a single Nvidia V100 GPU, and the embedding and verification stage is processed with an average inference speed of approximately 75 for identities per second without model deployment. Further deploying the model may increase the inference speed.

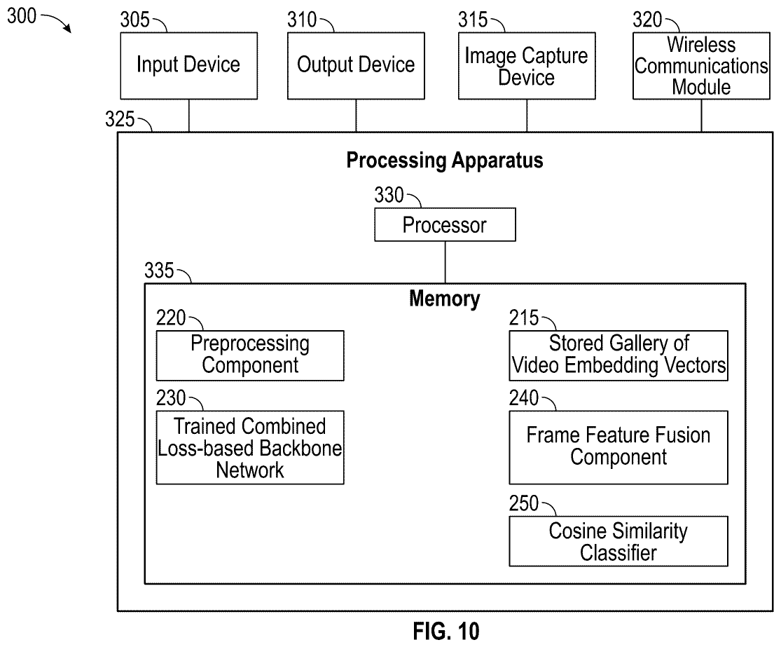

FIG. 10 is a block diagram of computing device 300 according to an exemplary embodiment of the disclosed concept that implements a local facial or finger video-based biometric identity verification system for facilitating biometric authentication of a user of computing device 300. Computing device 300 may be, for example and without limitation, a smartphone, a tablet computer or a PC. To implement the local facial or finger video-based biometric identity verification system, computing device 300 employs biometric identity verification architecture 200 of the disclosed concept.

Referring to FIG. 10, computing device 120 includes an input device 305 (such as a keyboard or touchscreen), an output device 310 (such as an LCD), a digital image capture device 315 (such as a CCD camera), a wireless communications module 320 (such as a Wi-Fi module and/or a broadband (e.g. cellular) wireless communication module) and a processing apparatus 325. A user is able to provide input into processing apparatus 325 using input device 305 and image capture device 315, and processing apparatus 325 provides output signals to output device 310 to enable output device 310 to display information to the user as described herein. Processing apparatus 325 comprises a processor 330 and a memory 335. Processor 330 may be, for example and without limitation, a microprocessor (μP), a microcontroller, or some other suitable processing device, that interfaces with memory 335. Memory 335 can be any one or more of a variety of types of internal and/or external storage media such as, without limitation, RAM, ROM, EPROM(s), EEPROM(s), FLASH, and the like that provide a storage register, i.e., a non-transitory machine readable medium, for data storage such as in the fashion of an internal storage area of a computer, and can be volatile memory or nonvolatile memory. Memory 335 has stored therein a number of routines (comprising computer executable instructions) that are executable by processor 330, including routines for implementing biometric identity verification architecture 200 of the disclosed concept as described herein. In particular, memory 335 includes stored gallery of video embedding vectors 215, preprocessing component 220, trained combined loss-based backbone network 230, frame feature fusion component 240, and cosine similarity classifier 250.

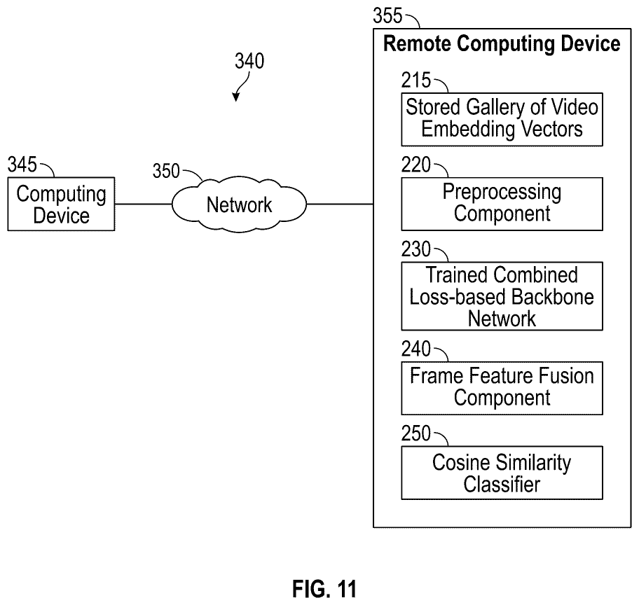

FIG. 11 is a facial or finger video-based biometric identity verification system 340 according to an alternative exemplary embodiment of the disclosed concept. As seen in FIG. 11, facial or finger video-based biometric identity verification system 340 includes a user computing device 345, such as a tablet computer, smartphone or PC, and a remote computing device 355, such as a server computer. User computing device 345 is similar to computing device 300 of FIG. 10, and includes an input device 305, an output device 310, an image capture device 315, a wireless communications module 320, and a processing apparatus 325. User computing device 345 and remote computing device 355 are able to securely communicate with one another via a wired and/or wireless network 350, including, for example, the Internet. In this embodiment, remote computing device 355 implements biometric identity verification architecture 200 remotely in order to allow a user of user computing device 300 to be authenticated. Thus, in operation, facial or finger videos captured by computing device 300 may be sent to remote computing device 340 for verification as described herein.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A method detecting a presentation attack in a computing device based on a finger or face image captured by an image capture device of the computing device without contacting the image capture device, wherein the finger or face image is in a first color space, the method comprising:
receiving a first color space image in the first color space, wherein the first color space image either is or is based on the finger or face image;
converting the first color space image into a number of additional color space images, wherein each additional color space image is in a color space other than the first color space; and
providing the first color space image and the number of additional color space images to a trained attention-leveraged data fusion-based classification system, wherein the trained attention-leveraged data fusion-based classification system includes a plurality of deep neural networks and a plurality of channel attention blocks, wherein each deep neural network is coupled to a respective one of the channel attention blocks, wherein each of the first color space image and the number of additional color space images is provided to a respective one of the deep neural networks, wherein for each deep neural network data based on first output features from the deep neural network is provided to the channel attention block of the deep neural network, wherein each attention block produces second output features, and wherein the trained attention-leveraged data fusion-based classification system classifies the finger or face image as a live image or a spoof based on the second output features from each of the channel attention blocks.

2. The method according to claim 1, further comprising using the classification of the digital finger or face image as a live image or a spoof to determine whether a user of the computing device should be authenticated.

3. The method according to claim 1, wherein the finger or face image is a segmented finger or face image created from an unsegmented finger or face image in the first color space, and wherein the method includes segmenting the segmented digital finger or face image to create the segmented finger or face image.

4. The method according to claim 3, wherein the segmentation is performed using a trained segmentation model.

5. The method according to claim 4, wherein trained segmentation model is a trained Faster R-CNN or a trained U-Net segmentation network.

6. The method according to claim 1, wherein the first color space is the RGB color space, and wherein the number of additional color space images includes a first additional color space image in the HSV color space and a second additional color space image in the YCbCr color space.

7. The method according to claim 1, wherein the second output features from each attention block are concatenated into a single combined feature map using element-wise summation, and wherein the trained attention-leveraged data fusion-based classification system classifies the finger or face image as a live image or a spoof based on the single combined feature map.

8. The method according to claim 7, wherein the single combined feature map is processed through batch normalization, ReLU activation, and global average pooling and then provided to a fully connected layer that makes a final decision on whether the finger or face image is live or a spoof.

9. The method according to claim 1, wherein for each deep neural network the data based on the first output features from the deep neural network is a pointwise convolution of the first output features from the deep neural network.

10. The method according to claim 1, wherein each channel attention block is a window channel attention block.

11. The method according to claim 10, wherein the second output features from each window attention block are combined into a single combined feature map and fed to a nested residual block, and wherein the trained attention-leveraged data fusion-based classification system classifies the finger or face image as a live image or a spoof based on an output of the nested residual block.

12. The method according to claim 11, wherein the output of the nested residual block are provided to a fully connected layer with a SoftMax layer, wherein an output of the SoftMax layer is subjected to dynamic quantization that quantizes model weights as lower-precision integers.

13. A computer program product, comprising a non-transitory computer usable medium having a computer readable program code embodied therein, the computer readable program code being adapted to be executed to implement a method of detecting a presentation attack in a computing device as recited in claim 1.

14. A computing device configured for detecting presentation attacks, comprising:
an image capture device; and
a processing apparatus implementing a trained attention-leveraged data fusion-based classification system and being structured and configured for:
receiving a first color space image in a first color space, wherein the first color space image either is or is based on a finger or face image captured by the image capture device without contacting the image capture device, wherein the finger or face image is in the first color space;
converting the first color space image into a number of additional color space images, wherein each additional color space image is in a color space other than the first color space; and
providing the first color space image and the number of additional color space images to the trained attention-leveraged data fusion-based classification system, wherein the trained attention-leveraged data fusion-based classification system includes a plurality of deep neural networks and a plurality of channel attention blocks, wherein each deep neural network is coupled to a respective one of the channel attention blocks, wherein each of the first color space image and the number of additional color space images is provided to a respective one of the deep neural networks, wherein for each deep neural network data based on first output features from the deep neural network is provided to the channel attention block of the deep neural network, wherein each attention block produces second output features, and wherein the trained attention-leveraged data fusion-based classification system is structured and configured to classify the finger or face image as a live image or a spoof based on the second output features from each of the channel attention blocks.

15. The computing device according to claim 14, wherein the processing apparatus is further structured and configured for using the classification of the digital finger or face image as a live image or a spoof to determine whether a user of the computing device should be authenticated.

16. The computing device according to claim 14, wherein the finger or face image is a segmented finger or face image created from an unsegmented finger or face image in the first color space, and wherein the processing apparatus is further structured and configured for segmenting the segmented digital finger or face image to create the segmented finger or face image.

17. The computing device according to claim 16, wherein the segmentation is performed using a trained segmentation model.

18. The computing device according to claim 17, wherein trained segmentation model is a trained Faster R-CNN or a trained U-Net segmentation network.

19. The computing device according to claim 14, wherein the first color space is the RGB color space, and wherein the number of additional color space images includes a first additional color space image in the HSV color space and a second additional color space image in the YCbCr color space.

20. The computing device according to claim 14, wherein the second output features from each attention block are concatenated into a single combined feature map using element-wise summation, and wherein the trained attention-leveraged data fusion-based classification system is further structured and configured for classifying the finger or face image as a live image or a spoof based on the single combined feature map.

21. The computing device according to claim 20, wherein the single combined feature map is processed through batch normalization, ReLU activation, and global average pooling and then provided to a fully connected layer that makes a final decision on whether the finger or face image is live or a spoof.

22. The computing device according to claim 14, wherein for each deep neural network the data based on the first output features from the deep neural network is a pointwise convolution of the first output features from the deep neural network.

23. The computing device according to claim 14, wherein each channel attention block is a window channel attention block.

24. The computing device according to claim 23, wherein the second output features from each window attention block are combined into a single combined feature map and fed to a nested residual block, and wherein the trained attention-leveraged data fusion-based classification system classifies the finger or face image as a live image or a spoof based on an output of the nested residual block.

25. The computing device according to claim 24, wherein the output of the nested residual block are provided to a fully connected layer with a SoftMax layer, wherein an output of the SoftMax layer is subjected to dynamic quantization that quantizes model weights as lower-precision integers.
